(19) United States
(12) Patent Application Publication
(10) Pub. No.: US 2016/0338909 A1
(43) Pub. Date: Nov. 24, 2016

(54) Keychain ready disposable medicine dispenser assembly

(71) Applicant: Mark J. Feld, Baltimore, MD (US)

(72) Inventor: Mark J. Feld, Baltimore, MD (US)

(21) Appl. No.: 14/545,527

(22) Filed: May 18, 2015

(51) Int. Cl. A61J 1/03; B65D 75/56; B65D 75/52; B65D 65/40; B65D 75/36

(52) U.S. Cl. CPC A61J 1/035; B65D 65/40; B65D 75/366; B65D 75/527; B65D 75/566

(57) ABSTRACT

A keychain ready disposable medicine dispenser assembly includes a) a plurality of individual dosage units removably connected to one another, each of said individual dosage units having a laminated card with a plurality of layers partially laminated to one another and with a dose of medication positioned between the layers to create a monodose blister cavity, and each of the dosage units having a keychain orifice; and, b) an assembly component for removably connecting the individual dosage units. Also separate, individual dosage units are included.

### REFERENCE TO RELATED APPLICATION(S)

This application has no related applications.

### BACKGROUND OF INVENTION

a. Field of Invention

The invention relates generally to keychain ready disposable medicine dispenser assemblies with separable individual dosage units, as well as separate individual disposable dosage units. Keychain medication devices have been available for years, but the medicine carrying devices are made of bulky metal or plastic components with complex movements and require the user to remember to refill. The problem becomes exacerbated when someone is away from medicine needed on an immediate or emergency basis and has no medication available or has failed to refill the old fashioned refillable devices. The present invention allows a user to carry medicine on a keychain, but with a significantly more compact, lighter device that is disposable, yet is also a more robust and convenient mechanism for use. The present invention assembly and individual units enable a user to purchase a number of individual units on a card and to remove monodose units and attach one to a keychain, as needed, and to then partake of the medicine, as needed.

b. Description of Related Art

The following patents and applications are representative of various types of related inventions:

U.S. Pat. No. 7,252,208 B1 to Frank Alvino describes a compact, portable tablet dispenser that is particularly adapted for carrying aspirin tablets for ingestion as therapy upon the onset of a suspected heart attack. The tablets are in a blister within the dispenser, which includes actuators aligned with the tablets to eject the tablets through an aperture in the dispenser. Upon operation, the actuators provide a permanent indication that a tablet has been ejected. The dispenser may include electronic circuitry to provide reinforcement and/or guidance, for its use and may include means for alerting a third party, such as by a 911 call, of its activation.

U.S. Pat. No. 6,758,338 B2 to Lynn Lien describes a pill dispenser comprises a lightweight container that carries a small number of doses (e.g., fewer than five and preferably one) of a medication to be taken during emergency or unexpected events. The device provides a symbolic indication of the nature of the event or condition for which the medication should be taken. The device may carry expiration date information for the medication. The device may also provide an environment proof closure to protect the medication, yet provide easy access to the medication when needed.

U.S. Pat. No. 6,382,410 B1 to Kenneth Magid describes a pill container for holding one or more pills that is attached to a key chain. The pill container has an overall appearance of an enlarged pill for ease in viewing and quick identification. The pill container includes an open top housing and a housing cover pivotally attached to the housing. The housing includes a bottom and an upwardly extending housing ring attached to the bottom of the housing. The housing can include one or more individual open top pill rings for holding individual pills apart from other pills. The pill rings are dimensioned for holding different size pills. Also, the housing may include an outwardly extending key chain ear attached to a portion of the housing ring. The ear is adapted for receiving a portion of a key chain. Further, the housing includes a post sleeve and a knob sleeve. The housing cover includes a top and a bottom portion. The bottom portion engages an edge of the housing ring when the housing cover is in a closed position on the open top housing. Also, the cover includes a downwardly extending vertical post and knob. The vertical post is dimensioned to be received in the top of the post sleeve in a press fit. The post is used as a hinge pin for pivoting the cover on top of the open top housing. The knob is dimensioned to be received in the top of the knob sleeve in a snap fit for holding the cover in a closed position on the housing.

U.S. Pat. No. 6,155,454 to Donald George describes a first embodiment of a pill dispenser that includes a pill carrier and dispenser housing. The pill carrier has a plurality of pill chambers, each of which initially holds a pill that is sealed from the outside environment by a pair of membranes. The dispenser housing has a pill carrier slot into which the pill carrier is disposed and an opening forming a pathway from the slot to the exterior of the housing. In addition, the dispenser housing has an integrated plunger disposed adjacent the slot and opposite the opening. This plunger has a projecting punch head capable of extending into a pill chamber to push a pill out of dispenser housing opening whenever the plunger is depressed by a user. The pill chamber is first placed in alignment with the punch head and housing opening by displacing the pill carrier within the pill carrier slot. An indexing mechanism is preferably used to ensure the necessary alignment. In a second embodiment of the pill dispenser, there are a plurality of integrated plungers, each of which forms a top covering of a respective one of the pill chambers. These plungers are capable of dispensing a pill contained within its associated pill chamber. In operation, the pill carrier is drawn out of the pill carrier slot to sequentially exposure of each of the pill chambers and allow the user to dispense a pill by actuating its associated plunger.

U.S. Pat. No. 5,915,560 to Donald George describes this invention relates to a compartmentalized pill dispenser that is small enough to be carried with the user at all times, seals the pills against moisture and other degrading elements, protects the pills against vibration and is easy to use by an impaired person in an emergency situation. The dispenser has a protective outer case which encases the internal pill carrier which having compartments for pills on one side thereof. The pill carrier is sealed within the sheath by a water-tight mechanism. The pill carrier is extended out of the case in one pill compartment increments to expose a pill.

U.S. Pat. No. 5,909,822 to Donald George describes a pill dispenser including a pill carrier having multiple through-holes forming pill chambers. Each of these pill chambers holds, at least initially, a pill which is sealed from the outside environment and completely contained within the pill chamber. The dispenser also has a housing with a pill carrier slot into which the pill carrier resides. There is a pill dispensing channel forming a pathway from the slot to the exterior of the dispenser housing. The pill carrier is displaceable within the slot which allows each pill chamber to be sequentially aligned with the channel. A plunger apparatus is positioned adjacent the slot and opposite the channel and is extended into a pill chamber, then in alignment with the channel, so as to push a pill contained within the pill chamber into the channel for dispensing. In an alternate embodiment, the pill dispenser includes a pill carrier similar to the first embodiment. However, in this embodiment there are multiple pill dispensing channels forming individual pathways from the slot to the exterior of the dispenser housing, and multiple corresponding plungers. Each plunger is located adjacent said pill carrier slot and opposite a different one of said plurality of pill dispensing channels. In addition, the pill carrier is situated such that each of the pill chambers is in alignment a different one of the plurality of pill dispensing channels. In this way, each plunger is capable of extending into a pill chamber so as to push a pill contained within the pill chamber into a channel for dispensing.

U.S. Pat. No. 5,058,405 to Woodrow Stillwagon describes a key chain with interior storage compartment closed by a cap to seal in solids, such as heart medication tablets or diabetes medication and which, preferably, is designed to additionally seal a container or vial which fits within the compartment for storing liquids, such as perfume, cologne, breath freshener, etc. which also features two key rings with a quick release mechanism to allow separation of the two rings.

U.S. Pat. No. 4,765,460 to Rafael Vigueras Pacheco describes a key-ring/pill-holder for carrying keys and pills that has a musket-type key ring having an attachment device for attaching the key ring to a garment, a key-attachment element for attaching a key, and a body having faces longitudinally therebetween. The pill holder is a cavity opening from one of the faces of the body of the key ring for holding pills and a sealing cap for closing the cavity opening closing and easily opening the same, whereby to provide a compartment for the pills until desired.

U.S. Patent Application No. DES. 433,935 to Kenneth Lewis describes a pill holder and dispenser with chain and ring support wherein the dispenser is permanently attached to the chain.

With some prior art devices for travelling with medicine, sometimes medications are transferred to small containers by the user themselves that are designed to allow a person to carry a few pills with them more conveniently. These containers usually take the form of a small tube with an inside diameter just larger than the pills. These containers are known to fail such as when the cap which seals the tube becomes cross threaded and stuck thereby making it difficult to remove. Also, the pills can be damaged in the small tube such as where normal movement causes the pills to tumble within the tube.

Another problem with small containers that are designed to be loaded by the patient is that they are typically not labeled and therefore the expiration date, type of medicine and dose are not available. After a period of time, or in the case of an elderly person with limited memory, this presents a dangerous situation in which a patient may ingest the wrong medication, medication that has expired or the wrong dosage of a desired medicine.

It is also known to use complex travel packs wherein a blister pack is placed into plastic pill dispenser box which houses the pack and allow the pills to be extracted. However, a drawback of this construction is that it involves two different items, namely, the blister pack and the pill dispenser box. This increases the cost of manufacture and of packaging, as well as increases chances of user error.

Notwithstanding the prior art, the present invention is neither taught nor rendered obvious thereby.

### SUMMARY OF INVENTION

The present invention is directed to a keychain ready disposable medicine dispenser assembly. The term “assembly” is used to mean more than one monodose unit connected to one another directly (e.g., separated by perforations, thins or other assembly means for subsequent separation) or indirectly (e.g., being adhered to the same backing or connected backings). Thus, the present invention assembly includes: a) a plurality of individual dosage units removably connected to one another, each of the individual dosage units having a laminated card with a plurality of layers partially laminated to one another and with a dose of medication positioned between said plurality of layers wherein at least one layer is formed to create a monodose blister cavity, each of the individual dosage units having a keychain orifice for passing a keychain therethrough; and, b) assembly means for removably connecting the plurality of individual dosage units. Thus, a user may remove an individual dosage unit from said assembly and attach it to a keychain for subsequent medicinal use, and subsequently remove said dose of medicine from said unit, as needed. The term “blister cavity” is used herein to mean a cavity in which medicine may be stored. It is not limited to the conventional blister pack concept (blister packs are thermoformed whereas the preferred embodiments of the present invention are stiffer and typically injected molded, although in some cases could be thermoformed). Therefore, “blister cavity” is any shape of holder for the medicine, e.g., a bubble dome, a box dome, a hemisphere dome, a semi-ovoid dome or other shape (geometric or irregular) may be used. “Monodose” here means a single dose of medicine and this could be one pill or tablet or more than one pill or tablet, or other, such as where two aspirin are recommended for headache and one dome with both aspirin pills or two domes, each with one aspirin pill, could be used and either would constitute a monodose individual dosage unit.

In some embodiments of the present invention keychain ready disposable medicine dispenser assembly, the laminated card is a combination of layers selected from the group consisting of paper, cardboard, plastic, metal foil and combinations thereof. In some instances, the card may be multiple layers of the same material, e.g., plastic, such as thermoformed plastics, non-thermoformed plastics and combinations thereof.

In some embodiments of the present invention keychain ready disposable medicine dispenser assembly, the laminated card is a combination of at least paper and plastic. Alternatively, two layers of the same or different plastics, or a layer of plastic and a layer of foil may be used. In some preferred embodiments, there are two layers. In many preferred embodiments, there are more than two layers.

In some embodiments of the present invention keychain ready disposable medicine dispenser assembly, the laminated card includes a layer of semi-rigid plastic.

In some embodiments of the present invention keychain ready disposable medicine dispenser assembly, the laminated card is a combination of at least two layers of plastic, including a base layer and a monodose blister pack layer.

In some embodiments of the present invention keychain ready disposable medicine dispenser assembly, the laminated card plastic base layer is a base layer of semi-rigid plastic.

In some embodiments of the present invention keychain ready disposable medicine dispenser assembly, the laminated card includes a peelable child resistant safety layer.

In some embodiments of the present invention keychain ready disposable medicine dispenser assembly, the assembly means is a separable portion of each of said individual dosage units to which each of said plurality of individual dosage units are removably connected to one another.

In some embodiments of the present invention keychain ready disposable medicine dispenser assembly, the dose of medication is selected from the group consisting of a powder, a tablet, a strip, a capsule and a gel cap. Preferably, the dose of medication is selected from the group consisting of a tablet, a capsule and a gel cap.

In some embodiments of the present invention keychain ready disposable medicine dispenser assembly, the monodose blister cavity for each unit is a single blister with said dose of medication contained therein. In other embodiments, the monodose blister cavity for each unit is at least two blisters with medication contained therein.

In some embodiments of the present invention, the invention is a single unit that may be manufactured separately or is separate because it has been separated from its assembly, as described above. Thus, the present invention keychain ready disposable medicine dispenser, includes: an individual dosage unit having a laminated card with a plurality of layers partially laminated to one another and with a dose of medication positioned between said plurality of layers to create a monodose blister cavity, said individual dosage unit having a keychain orifice for passing a keychain therethrough, wherein a user may attach said individual dosage unit to a keychain for subsequent medicinal use, and subsequently remove said dose of medicine from said unit, as needed.

In some embodiments of the present invention keychain ready disposable medicine dispenser, the laminated card is a combination of layers selected from the group consisting of paper, cardboard, plastic, metal foil and combinations thereof. Some embodiments are: that laminated card is a combination of at least paper and plastic; that the laminated card includes a layer of semi-rigid plastic; that the laminated card is a combination of at two layers of plastic, including a base layer and a monodose blister cavity layer; that the laminated card plastic base layer is a base layer of semi-rigid plastic; that the laminated card includes a peelable child resistant safety layer. All of the other detailed features set forth above as to the assembly's individual unit apply and may be included here as well.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is a top view of one present invention keychain ready disposable medicine dispenser assembly that has perforated tear out individual dosage units;

FIG. 2 is a side view of the present invention keychain ready disposable medicine dispenser assembly shown in FIG. 1;

FIG. 3 is a side cut view of an individual dosage unit removed from the present invention keychain ready disposable medicine dispenser assembly shown in FIGS. 1 and 2;

FIG. 4 is a side, partially cut view of the embodiment of the present invention individual dosage unit shown in FIG. 3, but now attached to a keychain and broken for medication removal and use;

FIG. 5 shows a top view of another present invention keychain ready disposable medicine dispenser assembly that has individual dosage units adhered to a backing and is a peel off array;

FIG. 6 is a top view of an individual dosage unit removed from the present invention keychain ready disposable medicine dispenser assembly shown in FIG. 5;

FIG. 7 is a top view of another present invention keychain ready disposable medicine dispenser, this one showing a powder medication;

FIG. 8 is a side, partially cut view of another embodiment of a present invention keychain ready disposable medicine dispenser assembly, with single capsule dosages and with crushable blisters; and,

FIG. 9 is a side, partially cut view of a removed, individual dosage unit from the embodiment of the present invention assembly shown in FIG. 8, but now attached to a keychain and broken for medication removal and use.

### DETAILED DESCRIPTION OF THE EMBODIMENTS

This invention is directed to keychain ready disposable medicine dispenser assemblies with separable individual dosage units, as well as separate individual disposable dosage units, to provide on the spot medication as needed. Thus, the present invention disposable individual dosage units may have one or two or more blisters, but typically will have one or two, as this is the norm for most monodose medicine applications. The present invention assemblies and units are intended to be superior to existing devices, yet easier to make and easier to use, as well as lighter and more compact than those currently available. Therefore, the present invention is directed to products for very convenient travel methods of carrying medication, with easy and simple access. The term “keychain” as used herein is meant to be broadly construed and to include linked chains, key rings, key books and other pocket carried key holders. The term “semi-rigid” is meant to not fold by normal hand effort, and is meant to include flexible and inflexible cards. For example, a credit card is semi-rigid and cannot be folded without great exertion.

Typically, people carrying medicine in the form of pills, tablets, strips, capsules or the like, simply keep the medication in its original container. This has numerous drawbacks: the original containers, such as conventional plastic pill bottles or full deck blister packs, are bulky; they are often noisy; they are not easily carried in one's pockets; they usually require complex access; and, they may result in damaged contents. As a result, the medicines are often left at home. The present invention provides for a compact and efficient product for transporting and consuming medicines, especially such medicines as are useful for heart conditions epileptic conditions, etc., but may be used for aspirins, other headache remedies, stomach remedies, antacids, prescription medicines and any OTC products used on an as needed or emergency basis.

In addition, the present invention assemblies and units provide for safe, pre-packaged, pre-labeled single use, portable device to carry medication.

These present invention individual dosage units are small, lightweight and convenient, so that they can be carried on a person at all times. On a keychain, the units would be easily accessible and its location never forgotten. The dispenser units would protect each pill or other medication form so that moisture, humidity, high temperature, shock and vibration would not have a detrimental effect on the pills.

Is is also important that the present invention assemblies may be easily displayed and sold in a plural cavity or a single cavity, and is easily sold in dispensing machines, as well as retailers, such as is in a chain pharmacy type setting where costs and shelf space are at a premium.

It is important to have the laminated card structure sufficiently stiff to not fold in one's pocket, such as the stiffness of a pharmacy or supermarket awards code card, commonly known as key tags. In addition, the blister in many instances is not easily crushable to protect the medication and is preferably not at all crushable. While the present invention monodose units are preferred to be attached to a keychain, they may alternatively be carried in a pocket, pocketbook, or other personal accessory, but are all readily attachable to keychains and are readily disposable when used.

Advantageously, the present invention units may be used to carry brand products of a particular store, e.g., discount club, supermarket or pharmacy and may additionally carry printed information, such as discount codes, promotions or premium give always that would be scanned at points of sale.

In many preferred embodiments of the present invention an injection molded piece is preferred instead of a thermoformed plastic, such as with a lid seal of foil or plastic) that will give the proper rigidity needed for long term pocket durability. This is especially true of emergency medicines and most other medicines, such as nitro pills for certain heart issues. On the other hand, for single travel medication wherein long term durability may not be need, such as flight sickness pills taken on a plane, then the strong stiffness is not required and some thermoformed cavities could be used. But for most applications, the injected molded cavities are necessary for the desired rigidity and durability.

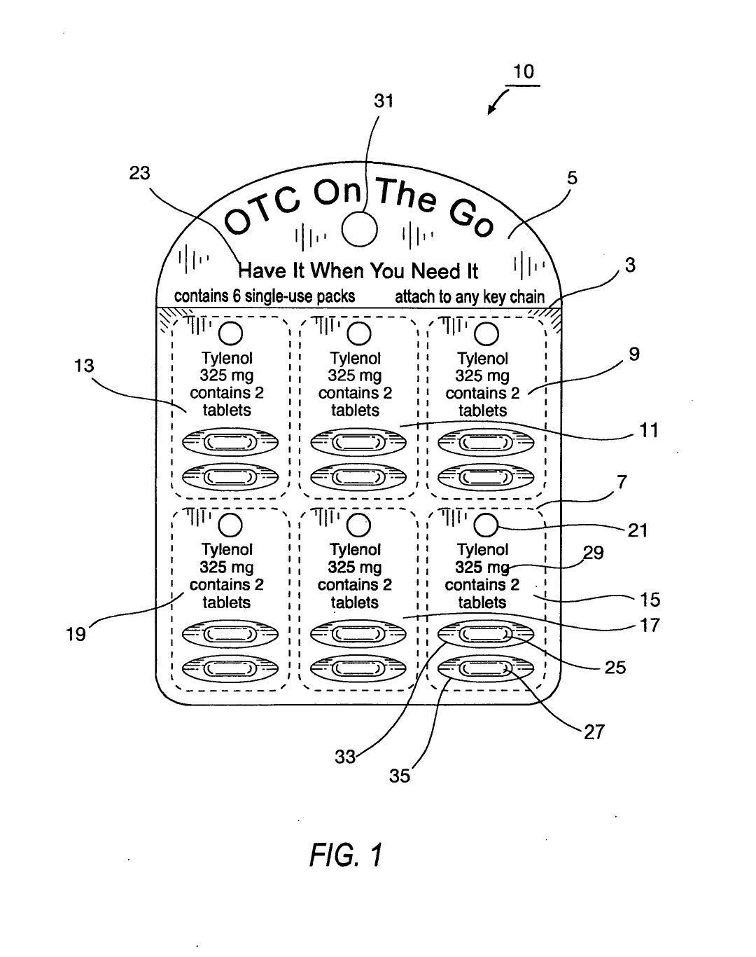

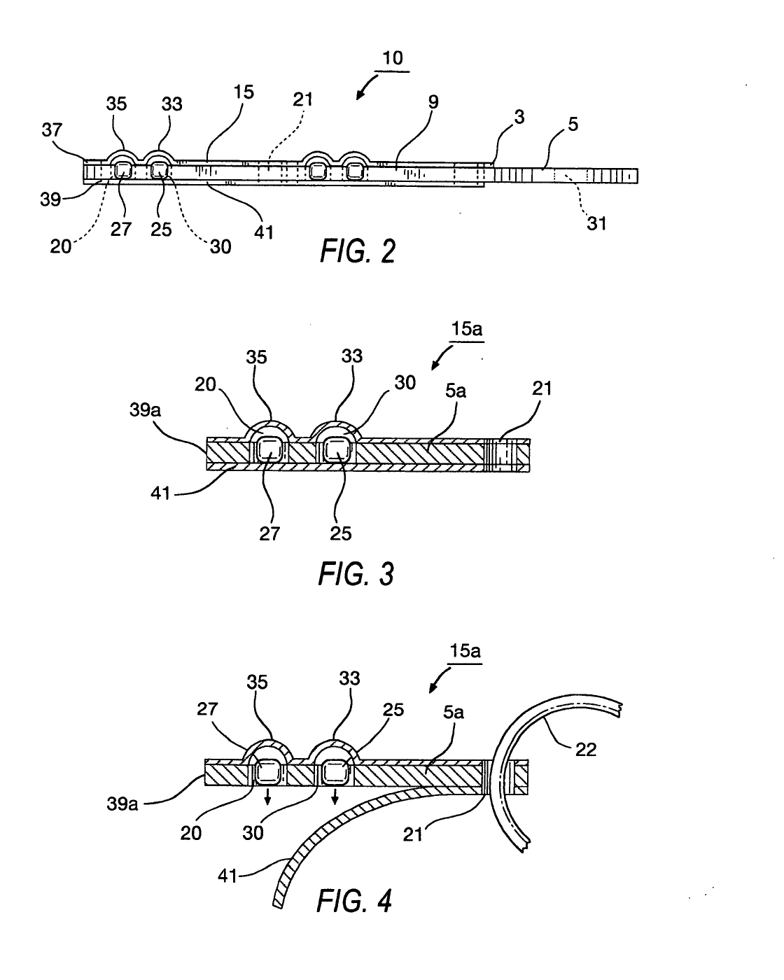

FIG. 1 is a top view of one present invention keychain ready disposable medicine dispenser assembly 10 that has perforated tear out individual dosage units. Present invention assembly 10 has a full length base layer 5 with an optional display sales rack orifice 31. Base layer 5 may be plastic or paper (“paper” means any cellulosic-based member, such as sheet paper, packed cardboard, paper with strengthening fibers of cellulosic or non-cellulosic mater, etc.) and may be when alone, flexible and even foldable, but when laminated, it is rigid to at least bendable. Base layer 5 has a clear plastic layer 3 that begins at about the solid line below the header print down to the lower end of layer 5. Individual dosage units are established by portions of layer 5 and clear plastic layer 3. These individual dosage units are units 9, 11, 13, 15, 17 and 19, each being peripherally defined by perforations thereabout, such as perforations 7 that define individual dosage unit 15. Further, each of the individual dosage units 9, 11, 13, 15, 17 and 19 have orifices fro key rings or chains or other pocket device fastening, such as orifice 21 on individual dosage unit 15. In this embodiment, all of the individual dosage units 9, 11, 13, 15, 17 and 19 have two blister cavities, each housing a single pill, tablet or capsule. Again, looking at individual dosage unit 15, one can see blister cavities 33 and 35 with medicine 25 and 27 respectively contained therein. Individual dosage units 9, 11, 13, 15, 17 and 19 all have individual users instructions, such as instructions 29 on individual dosage unit 15. Other information/instructions/advertising/logo may be displayed on header 23 of layer 5, as shown. Many variations are possible, such as the clear plastic layer 3 covering the entire top of layer 5. More details of this FIG. 1 embodiment are shown in FIGS. 2, 3 and 4 below, wherein identical parts are identically numbered and need not be repeated here in their entirety. However, in a most preferred embodiment, the base layer is a single injection molded plastic layer and has a single blister cavity-creating top laminated layer, which is preferably a single lidding material, such as foil. (By “laminated” as used herein is meant any two layers of the same or different materials that are at least partially bonded together by any means, in the same plane, e.g., by gluing, heat melding chemical bonding or otherwise.)

FIG. 2 is a side view of the present invention keychain ready disposable medicine dispenser assembly 10 shown in FIG. 1. In addition to the parts discussed above, there are shown pill drop orifices, such as orifices 20 and 30 at individual dosage unit 15. (In this FIG. 2, unit 15 is still part of assembly 10; in FIGS. 3 and 4 it is removed from the assembly 10 and hence designated as unit 15a.)

Note that in FIG. 2, blister cavities 33 and 35 and their contents are more fully shown and the drop orifices 20 and 30 are clearly illustrated as well. The drop orifices are covered by heavy duty adhesive strip 41, which is peelable for pill dispensing. FIG. 3 is a side cut view of individual dosage unit 10a removed from the present invention keychain ready disposable medicine dispenser assembly 10 shown in FIGS. 1 and 2. Note that the orifice 21 is cut through strip 41 whereas the drop orifices 20 and 30 are not. The unit 10 is put on a key ring, keychain or other key-attachable pocket device and is ready for use as needed.

FIG. 4 is a side, partially cut view of the embodiment of the present invention individual dosage unit 10a shown in FIG. 3, but now attached to a keychain ring 22 and broken for medication removal and use. This illustration shows the unit 15a with its bottom facing down merely to illustrate that once the strip 41 is peeled, the medicine may be removed by gravity.

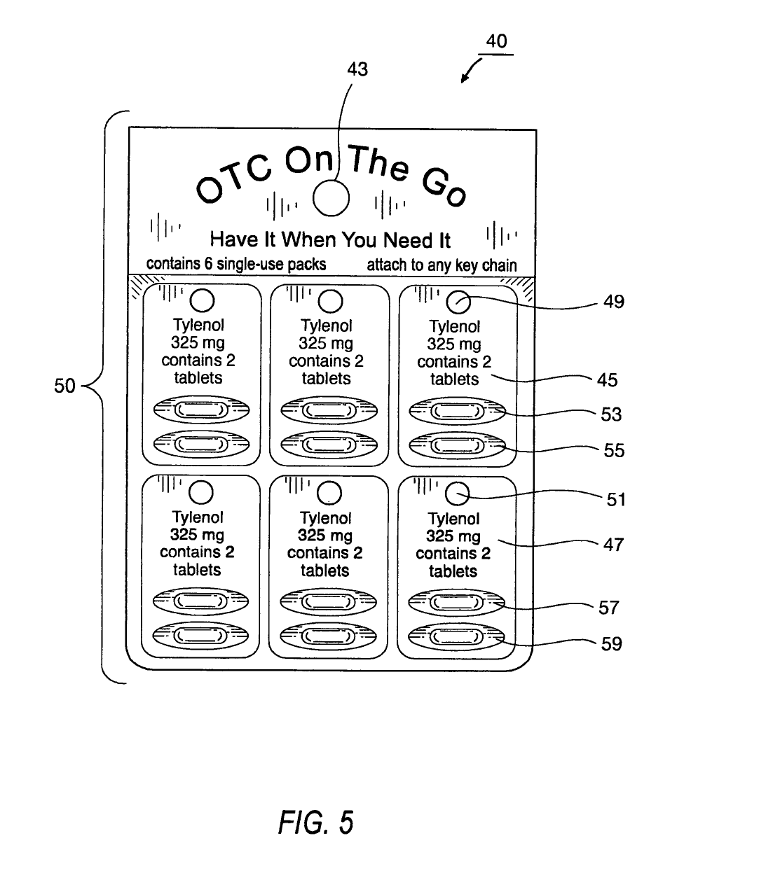

FIG. 5 shows a top view of another present invention keychain ready disposable medicine dispenser assembly 40 that has preformed individual dosage units that are subsequently adhered to a backing, creating a peel off assembly. This includes a base layer 50 with a rack orifice 43, and six separately made individual dosage units, such as units 45 and 47. These two exemplary units 45 and 47 as do all units on assembly 40, have foil backs that are punctureable and have adhesives to stick to base layer 50. They may be peeled off individually for key chain or ring attachment and for subsequent use they are punctured from medicine release. Units 45 and 47 respectively have key chain orifices 49 and 51 and double medicine blister cavities 53 and 55, and 57 and 59.

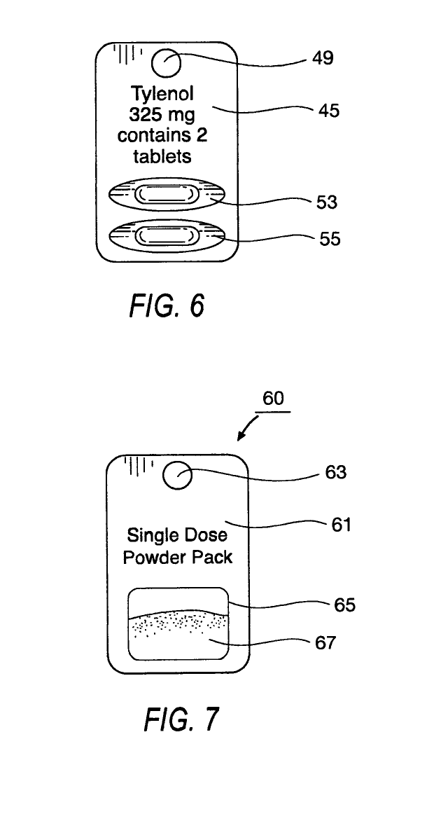

FIG. 6 is a top view of an individual dosage unit 45 removed from the present invention keychain ready disposable medicine dispenser assembly 40 shown in FIG. 5. This is approximately actual size and illustrates the compactness and convenience of this monodose disposable unit. Components identical to those shown in FIG. 5 are identically numbered.

FIG. 7 is a top view of another present invention keychain ready disposable medicine dispenser unit 60, this one showing a powder medication. In this embodiment, there is a base layer 61 and a laminated bubble cavity 65 with powder medicament. In this case, there is a pull strip or adhered foil on the bottom (not shown) for pull and dump usage.

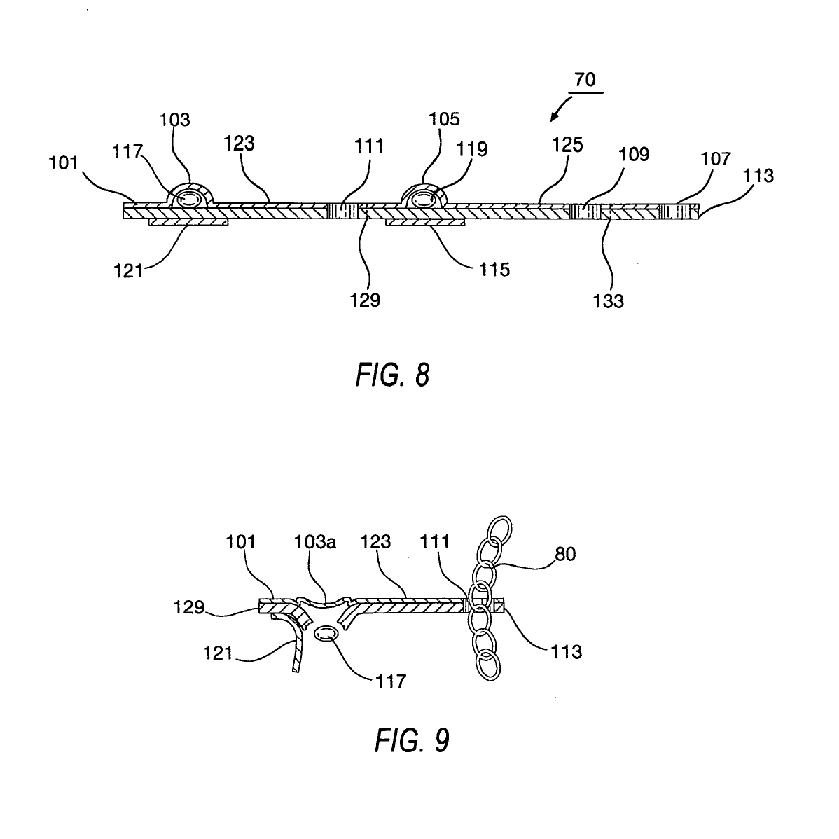

FIG. 8 is a side, partially cut view of another embodiment of a present invention keychain ready disposable medicine dispenser assembly 70, with single capsule dosages and with crushable blister cavities. Assembly 70 includes a laminated structure that has a top layer 101 with blister cavities 103 and 105, a base layer 113 and a rack orifice 107. Each blister cavity 103 and 105 contains one medicine caplet 117 and 119 respectively. Each has key ring orifices 111 and 109. There are perforations as in FIG. 1, such as perforations, 129 and 133, for separating the individual dosage units 123 and 125. There are also security strips 121 and 115 that must be peeled to puncture the base layer 113 below the blister cavities 103 and 105 to remove medicine caplets 117 and 119. Thus, FIG. 9 is a side, partially cut view of caplet 117 being removed from individual dosage unit 123 from the embodiment of the present invention assembly 70 shown in FIG. 8. It is now attached to a keychain 80. Note that first, safety strip 121 has been removed, and, second, blister cavity 103 has been crushed and layer 113 broken for medication removal and use.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

1-20. (canceled)

21. A disposable medicine dispenser assembly having individual dosage units for attachment to a keychain, which comprises:
a) a plurality of individual dosage units connected to one another, each of said individual dosage units having a laminated card with a plurality of layers partially laminated to one another, one of said plurality of layers being a protective base layer of semi-rigid plastic card material with at last one monodose blister cavity, and with a dose of medication positioned between said plurality of layers in said at least one monodose blister cavity, and each of said individual dosage units having a keychain orifice for passing a keychain therethrough; and,
b) a plurality of perforations, that peripherally define each of said plurality of individual dosage units, adapted for removing said plurality of individual dosage units from one another;
wherein a user may remove an individual dosage unit from said assembly by tearing at said perforations, and attach it to a keychain for subsequent medicinal use, and for subsequently removing said dose of medication from said unit as needed.

22. The disposable medicine dispenser assembly of claim 21 wherein said laminated card is a combination of layers selected from the group consisting of paper, cardboard, plastic, metal foil and combinations thereof.

23. The disposable medicine dispenser assembly of claim 22 wherein said laminated card is a combination of at least paper and plastic.

24. The disposable medicine dispenser assembly of claim 22 wherein said laminated card is a combination of at least two layers of plastic, including said base layer and a monodose blister cavity layer.

25. The disposable medicine dispenser assembly of claim 21 wherein said base layer is an injection molded stiff plastic.

26. The disposable medicine dispenser assembly of claims 25 wherein said injection molded stiff plastic is not foldable in a pocket.

27. The disposable medicine dispenser assembly of claim 21 wherein said laminated card includes a peelable child resistant safety layer.

28. The disposable medicine dispenser assembly of claim 21 wherein said dose of medication is selected from the group consisting of a tablet, a capsule and a gel cap.

29. The disposable medicine dispenser assembly of claim 28 wherein said dose of medication is selected from the group consisting of a capsule and a gel cap.

30. The disposable medicine dispenser assembly of claim 28 wherein said at least one monodose blister cavity is two monodose blister cavities, each with medication contained therein.

31. The disposable medicine dispenser assembly of claim 21 wherein said monodose blister cavity is a single blister with said dose of medication contained therein.

32. The disposable medicine dispenser assembly of claim 21 wherein said monodose blister cavity is at least two blisters with medication contained therein.

33. A disposable medicine dispenser for attachment to a keychain, which comprises:
an individual dosage unit having a laminated card with a plurality of layers partially laminated to one another, one of said plurality of layers being a base layer of semi-rigid plastic card material with at least one monodose blister cavity, and with a dose of medication positioned between said plurality of layers in said at least one monodose blister cavity, said individual dosage unit having a keychain orifice for passing a keychain therethrough;
wherein a user may attach said individual dosage unit to a keychain for subsequent medicinal use, and subsequently remove said dose of medication from said unit, as needed.

34. The disposable medicine dispenser of claim 33 wherein said laminated card is a combination of layers selected from the group consisting of paper, cardboard, plastic, metal foil and combinations thereof.

35. The disposable medicine dispenser of claim 34 wherein said laminated card is a combination of at least paper and plastic.

36. The disposable medicine dispenser of claim 34 wherein said base layer is an injection molded stiff plastic.

37. The disposable medicine dispenser of claim 36 wherein said injection molded stiff plastic is not foldable in a pocket.

38. The disposable medicine dispenser of claim 33 wherein said laminate substrate includes a peelable child resistant safety layer.

39. The disposable medicine dispenser of claim 34 wherein said laminated card is a combination of at two layers of plastic, including said base layer and a monodose blister cavity layer.

40. The disposable medicine dispenser of claim 39 wherein said at least one monodose blister cavity is two monodose blister cavities, each with medication contained therein.
